(19) United States
(12) Patent Application Publication
(10) Pub. No.: US 2012/0110628 A1
(43) Pub. Date: May 3, 2012

(54) Storage of Adaptive Streamed Content

(76) Inventor: Brant L. Candelore, San Diego, CA (US)

(21) Appl. No.: 12/913,010

(22) Filed: Oct. 27, 2010

(51) Int. Cl. H04N 7/173

(52) U.S. Cl. 725/110; 725/116

(57) ABSTRACT

A method consistent with certain implementations involves receiving adaptively streamed data representing the A/V content from a source. The stream contains a high resolution representation of a first portion of the content and a lower resolution representation of a second portion; storing the stream of data to an electronic storage device; determining that the stored stream of data includes the lower resolution representation of the second portion of the content; changing the lower resolution representation of the second portion of the content to a high resolution representation of the second portion of the content; and producing a high resolution output stream of data representing the A/V content by combining the high resolution representation from the storage device with the high resolution representation of the second portion of the content. This abstract is not to be considered limiting, since other embodiments may deviate from the features described in this abstract.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Adaptive streaming works by reducing the resolution of segments of content to lower the effective bandwidth requirement of a network connection. This allows continuous viewing of an adaptively streamed program such as an Internet Protocol Television (IPTV) program that is being watched.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is an example of an implementation of an adaptive streaming IPTV system consistent with certain embodiments of the present invention.

FIG. 2 is an example block diagram of an implementation of an IPTV receiver system consistent with certain embodiments of the present invention.

FIG. 3 is an example diagram of implementing upgraded storage of lower resolution portions of adaptively streamed content in a manner consistent with certain embodiments of the present invention.

FIG. 4 is another example diagram of implementing upgraded storage of lower resolution portions of adaptively streamed content in a manner consistent with certain embodiments of the present invention.

FIG. 5 is another example diagram of implementing upgraded storage of lower resolution portions of adaptively streamed content in a manner consistent with certain embodiments of the present invention.

FIG. 6 is an example of a block diagram of an implementation of playback of stored content in a manner consistent with certain embodiments of the present invention.

FIG. 7 is another example of a block diagram of an implementation of playback of stored content using supplemental streaming in a manner consistent with certain embodiments of the present invention.

FIG. 8 is an example flow chart depicting implementation of an overall process consistent with certain embodiments of the present invention.

FIG. 9 is a more detailed example flow chart depicting an implementation of an overall process consistent with certain embodiments of the present invention.

FIG. 10 is a more detailed example flow chart depicting another implementation of an overall process consistent with certain embodiments of the present invention.

FIG. 11 is a more detailed example flow chart depicting another implementation of an overall process consistent with certain embodiments of the present invention.

FIG. 12 is a more detailed example flow chart depicting another implementation of an overall process consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “adaptive streaming” and similar terms for purposes of this document are intended to mean streamed data representing audio and/or video content that is streamed in such a manner that the resolution of the stream is adapted according to available bandwidth. Hence an adaptively streamed video stream may include portions that are streamed at a resolution suitable for display at 1080p resolution and portions that are suitable for display at 480p resolution, for example, within the same program content. Use of such adaptive streaming allows for higher likelihood of uninterrupted viewing of video content when dynamic bandwidth demands consume bandwidth that would be needed to transfer the video data with higher resolution.

Adaptive streaming is, at this writing, being considered for standardization for Internet Protocol Television (IPTV) by the Open IPTV forum, but no standard currently exists. The resolutions used at any instant for adaptive streaming can be determined dynamically either by the transmission side, the receiving side, a combination of both or by other entities that control available bandwidth. Adaptive streaming generally allows less content to be cached and does not depend on a single measurement of the connection. The resulting downloaded file can be affected however with higher and lower resolution segments in the adaptively streamed content.

For purposes of this document, it is understood that the terms “high”, “low”, “higher”, and “lower” are relative terms. When used in the context of video resolution, the terms as used herein are relative to one another. So, a high resolution video signal is higher in resolution than a lower resolution video signal. Thus, the terms are generally to be considered as a comparison with another resolution. The term “intermediate” is used to mean that there is a resolution higher and a resolution lower. Hence, a video signal with enough information to support a 1080p display is higher in resolution than a video signal with enough information to support a 720p display, which is in turn higher in resolution than a video signal with only enough information to support a 480p display. In this example, the video signal that supports a 720p display is “intermediate” to the higher resolution signal that can support a 1080p display and the lower resolution signal that can support a 480p display. Accordingly, there is no need to rely on absolutes in this context since the use of “high”, “low” and “intermediate” are with respect to other video resolutions.

As previously noted, adaptive streaming works by reducing the resolution (“downres'ing”) of segments of content to lower the effective bandwidth requirement of a network connection. This allows continuous viewing of an adaptively streamed program that is being watched in real time or near real time. One problem with this approach is that if the file is also being downloaded and stored to local storage (e.g., in a digital video recorder—DVR), then it will have lower resolution segments included with higher resolution segments. The result will not be what the viewer might expect, and it might be particularly annoying when the viewer pays a subscription or pay per view type fee for access to the content. The resulting downloaded file would not be desirable in a permanent or temporary (e.g., if the viewer has rights to view the content for a specified period of time) archive. For purposes of this document, the terms “real time” and “near real time” are considered equivalent and mean that the display or playing of content occurs at substantially the time of the receipt of the stream or within a few seconds thereof so as to be perceived by the user as occurring near instantaneously.

“Local storage” as used herein is intended to mean storage at the user's premises, for example in a digital video recorder (DVR—also known as a personal video recorder or PVR), at a set top box (STB) or any other storage device residing at the user's premises and operatively coupled to a home video entertainment system including a networked video server.

In accord with certain example implementations of embodiment of the invention, this problem can be resolved in several ways: 1) On future playback, the player recognizes that a lower resolution segment is in the file, and retrieves the higher resolution segment to be streamed in real-time, or 2) After a download has initially “completed”, a quality assurance routine checks each segment of a file. If a higher resolution segment is available, the segment is re-downloaded. As an adjunct to this process, it is also possible to either stream supplementary data that converts the lower resolution data (e.g., the higher frequency components) to higher resolution in real time or in order to upgrade the stored content that is of lower resolution.

These solutions may result in a longer download session with a customer who is also viewing the content at the same time since some segments will have to be downloaded twice—once in the lower resolution format (for real-time viewing) and once in the higher resolution format. Additionally, more downloaded bits are often needed to deliver content with this approach. However, the end result should be a consumer that is happier because the content (e.g., a movie or TV program or the like) that is downloaded will be in the highest resolution that the customer paid for.

This problem of playback of locally stored content having lower resolution portions, to the knowledge of the inventor has been unrecognized and unaddressed heretofore in the field of adaptive streaming. This problem is particularly relevant to IPTV where bandwidth fluctuation is common and may result in the need for adaptive streaming to avoid pauses in streaming in situations where the user cannot rely on having a defined bandwidth dedicated to the video stream.

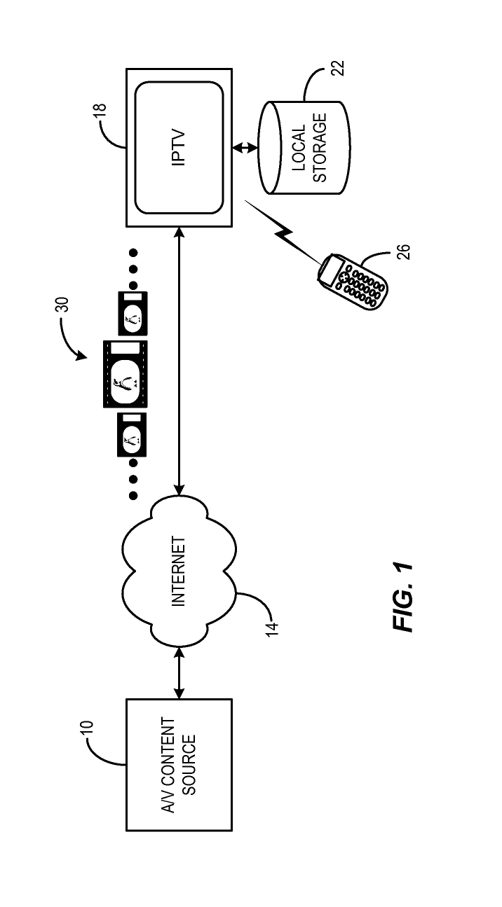

Turning now to FIG. 1, FIG. 1 depicts an example of an implementation of an adaptive streaming IPTV system consistent with certain embodiments of the present invention. In this example, A/V content such as television programming or movies or the like are streamed from a content source 10, through the Internet 14 to an IPTV receiver device 18. In accord with the discussion above, the IPTV receiver 18 may be embodied within a television set, a DVR, a STB or any other configuration of receiver and can generally be played (displayed on the receiver device's display) in real time or near real time as the stream is being received. For simplicity of illustration, any operative combination of such devices or other equivalents is simply depicted as IPTV 18. One or more local storage devices 22 are operatively coupled to the IPTV system 18 in order to store and play back stored content stored on the local storage device(s). Generally, a remote controller 26 is used to control operation of the IPTV system and storage and playback of the content stored on local storage device 26.

The adaptive streamed content is depicted by 30 where higher resolution portions are depicted as larger film frames and lower resolution portions are depicted as smaller film frames by way of a metaphor. The resolution of the content is adapted according to any number of possible mechanisms that are beyond the scope of this discussion, but can be throttled up or down by any mechanism including feedback derived at the content source from the IPTV system or any other measurement mechanisms that provide information as to the available bandwidth at any given instant over any portion of the path between the content source 10 and the IPTV 18.

Generally speaking, one of the main objectives of adaptive streaming is to provide the viewer with a continuous flow of real time A/V content without need to pause or otherwise disrupt the presentation due to a shortage of bandwidth. Adaptive streaming also minimizes need for buffering to account for loss of bandwidth that may be recaptured in bursts. Adaptive streaming is achieved by determining that there is not enough bandwidth at a given point in time and instead of attempting to send too much data in real time (resulting in a pause in presentation of the data, for example) and instead of sending data that would overload the bandwidth capacity of the network, a lower resolution version of the content that can fit into the available bandwidth is streamed until a hopefully temporary bandwidth shortage passes and full high resolution streaming can resume. If the time during which the low resolution version is short, this technique will provide minimal disruption to the viewing experience.

However, when the content is also stored, the user winds up with a stored copy of the content that is of lower resolution than is optimal—and perhaps lower than the user paid for. The present subject matter addresses this problem.

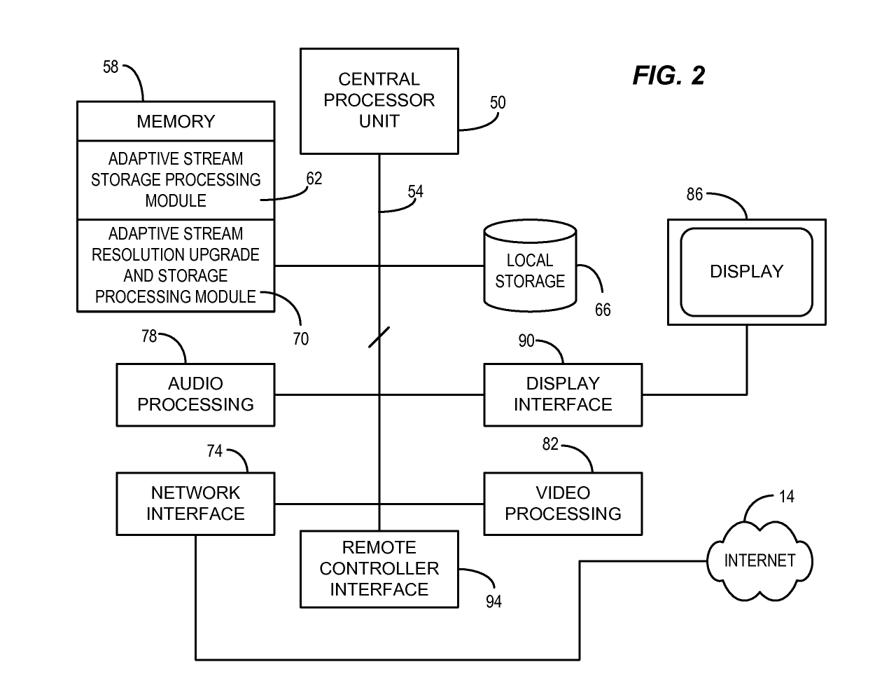

FIG. 2 is an example block diagram of an implementation of an IPTV receiver system consistent with certain embodiments of the present invention. It is to be understood that this figure depicts elements of the receiver system without regard for whether they are embodied within a single device such as a STB or TV or whether the various components are distributed among multiple devices at the user's premises. The receiver system includes one or more central processors 50 that are programmed to carry out receipt and display and storage of adaptively streamed content. Interconnection of the processor(s) with other system components is depicted as a bus 54, but it is to be understood that a multiple bus arrangement is equally applicable and possibly necessary when the various components are housed in separate devices.

The processor 50 is programmed by loading of program modules or other arrangements of instructions into a memory 58. In this implementation, the memory 58, among other things, includes a module 62 that handles storage of the adaptively streamed content to local storage device (e.g., a disc drive or solid state drive) 66. Memory 58 also stores a module 70 that attends to upgrading the resolution of the content stored on disc drive 66. In accord with various example implementations consistent with embodiments of the present invention, when an adaptively streamed program is stored to local storage 66, the resolution of lower resolution portions of the content are upgraded so that when the user plays the content at a later time, the user is able to view the content in full high resolution.

The A/V content is adaptively streamed from the Internet 14 and received at a network interface 74 which passes the data along to the audio processing circuits 78 and the video processing circuits 82 for ultimate display on display 86 via the display interface 90. The overall operation may be controlled by any suitable user interface including remote controller 94, with the programmed processor(s) 50 controlling all operations under program control.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using hard disc storage, semiconductor disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

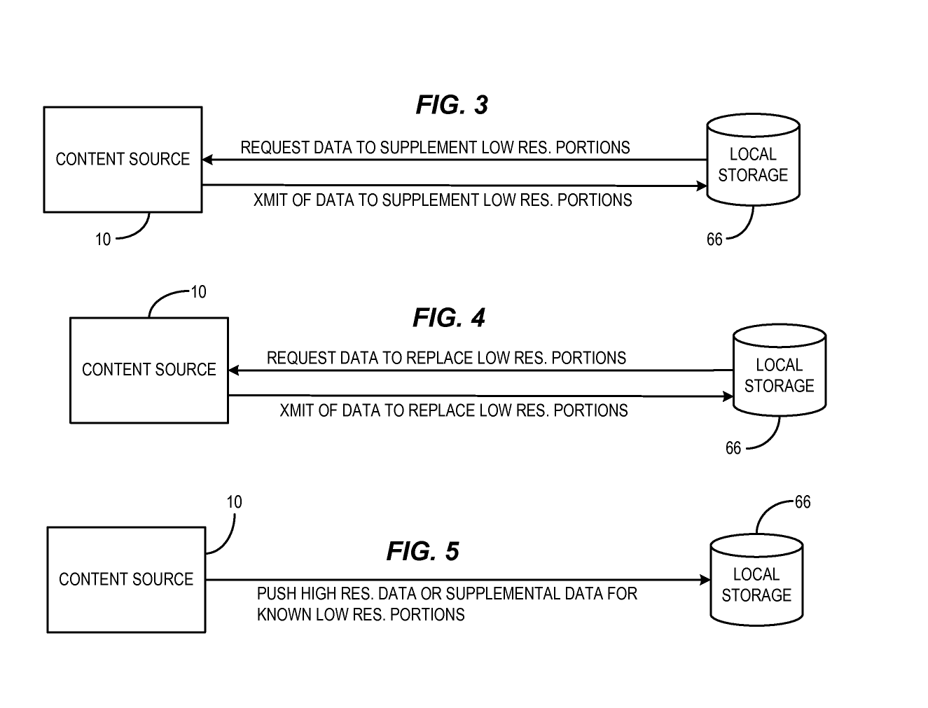

FIG. 3 is an example diagram of implementing upgraded storage of lower resolution portions of adaptively streamed content in a manner consistent with certain embodiments of the present invention. This diagram is a simplified diagram depicting a mechanism wherein the processor at local storage 66 sends a message to content source 10 requesting that data be sent to supplement the low resolution portions of content stored at local storage 10. Responsive to this request, the content source 10 sends data to be stored at local storage 66 that supplements the data already stored at local storage 66 that collectively produces a stored version of the content in a higher resolution form. By way of example and not limitation, higher resolution versions often simply contain more of the higher frequency video information. This high frequency information can be separately sent and under processor control merged with the existing lower resolution content to produce the equivalent of high resolution content stored locally.

FIG. 4 is another example diagram of implementing upgraded storage of lower resolution portions of adaptively streamed content in a manner consistent with certain embodiments of the present invention. This diagram is a simplified diagram depicting a mechanism wherein the processor at local storage 66 sends a message to content source 10 requesting that high resolution data be sent to replace the low resolution portions of content stored at local storage 10. Responsive to this request, the content source 10 sends a high resolution version of the low resolution data currently stored at local storage 66 that is used to replace the low resolution data stored at local storage 66. This produces a full high resolution copy of the content stored locally at 66.

FIG. 5 is another example diagram of implementing upgraded storage of lower resolution portions of adaptively streamed content in a manner consistent with certain embodiments of the present invention. This diagram is a simplified diagram depicting a mechanism wherein the content source retains knowledge and thus already knows that lower resolution content is being stored at local storage 66. The content source 10 then pushes, as bandwidth permits, higher resolution data to replace the low resolution portions of content stored (or not) at local storage 10. This high resolution version of the low resolution data currently stored at local storage 66 is used to replace the low resolution data stored at local storage 66. This again produces a full high resolution copy of the content stored locally at 66.

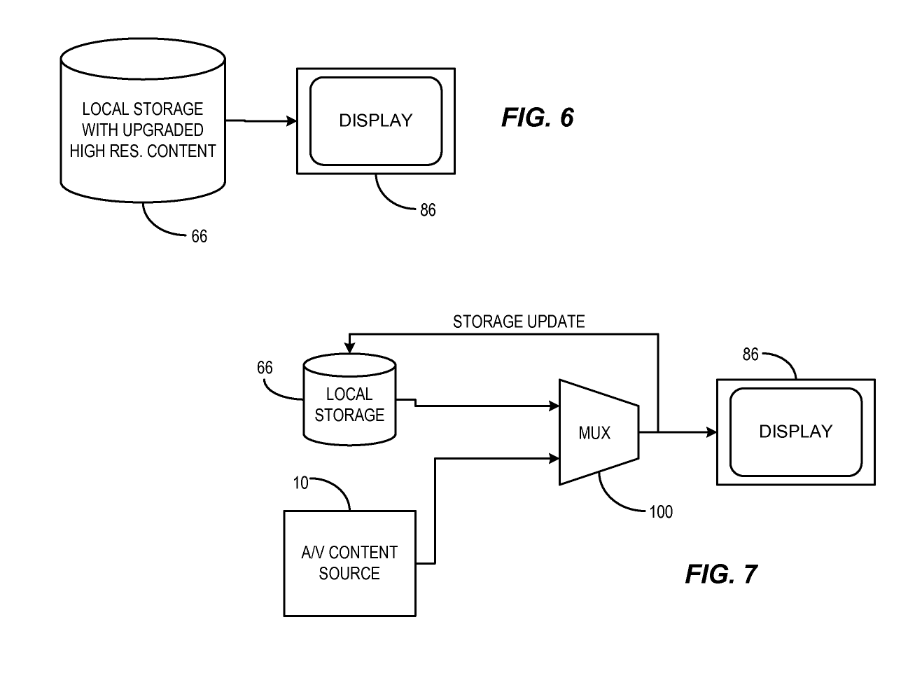

FIG. 6 is an example of a simplified block diagram depicting playback of stored content in a manner consistent with certain embodiments of the present invention. In any of the cases depicted in FIGS. 4-6, the version of the content stored in local storage 66 is upgraded to a higher resolution version of the content. Hence, during playback, a full high resolution version of the A/V content is available at local storage 66 and can therefore be streamed directly from local storage to display on display 86.

FIG. 7 is another example of a simplified block diagram of an implementation of playback of stored content using supplemental streaming in a manner consistent with certain embodiments of the present invention. In this case, the locally stored data at 66 still contains a copy of the adaptively streamed content and thus has high resolution portions of content and low resolution portions of content. Responsive to a user command for playback, the locally stored higher resolution portions are combined at a multiplexing function 100 (which can be implemented in processor 50 as a part of module 70) with streamed high resolution versions of the lower resolution content stored at local storage 66, where the higher resolution versions are streamed in real time or near real time from content source 10. In this implementation, the higher resolution streamed version of low resolution content can either be streamed in full to replace the low resolution portions, or supplemental data such as higher frequency components can be streamed to supplement the lower resolution portions to render them in higher resolution. In addition, the output stream can be restored at 66 to replace the stored content in whole or in part to increase the resolution of the lower resolution portions of the content.

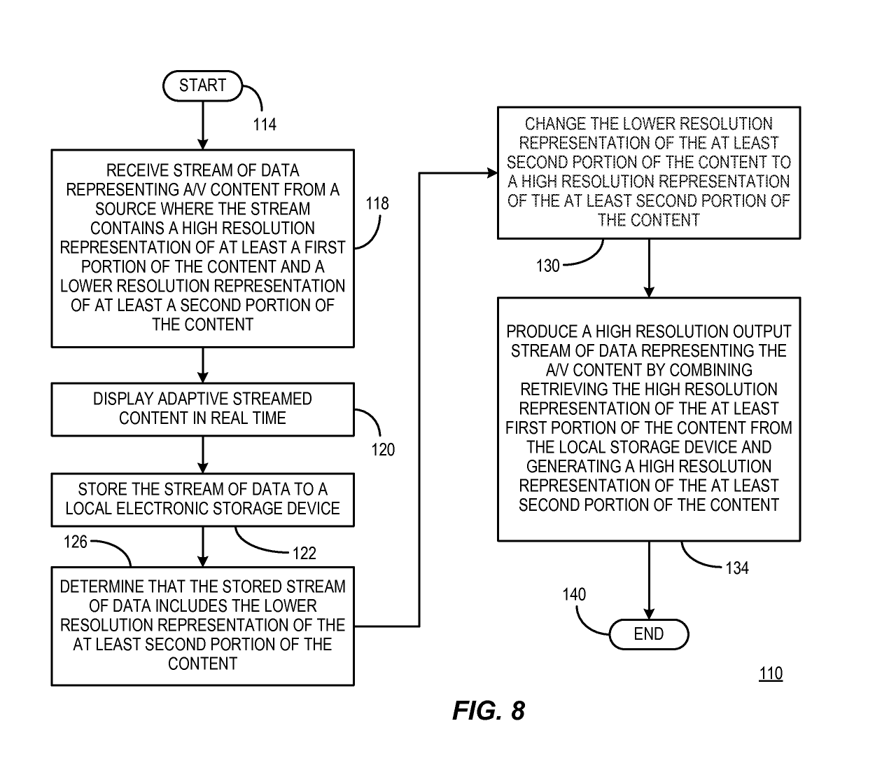

FIG. 8 is an example flow chart depicting implementation of an overall process consistent with certain embodiments of the present invention depicted as process 110 starting at 114. In this method 110, an adaptively streamed stream of data representing the A/V content is received from a source at 118. The stream contains at least a high resolution representation of at least a first portion of the content and a lower resolution representation of at least a second portion of the content. But, the stream may also include other varying degrees of resolution including intermediate resolution versions of the content. This stream can be viewed in real time at 120 as it is being received, with the resolution of display varying as the lower and higher resolution portions are received. The stream of data is stored at 122 to the electronic storage device 66 at the various resolutions received. A determination is made at 126 that the stored stream of data includes the lower resolution representation of the at least second portion of the content. The processor then operates to change the lower resolution representation of the at least second portion of the content to a high resolution representation of the at least second portion of the content at 130 to produce a high resolution output stream of data representing the A/V content by combining the high resolution representation of the at least first portion of the content from the storage device with the high resolution representation of the at least second portion of the content at 134 and the process ends at 140. The conversion at 130 can be carried out using any of the processes depicted above to either upgrade the stored version of the content or supplement it with real time or near real time streaming.

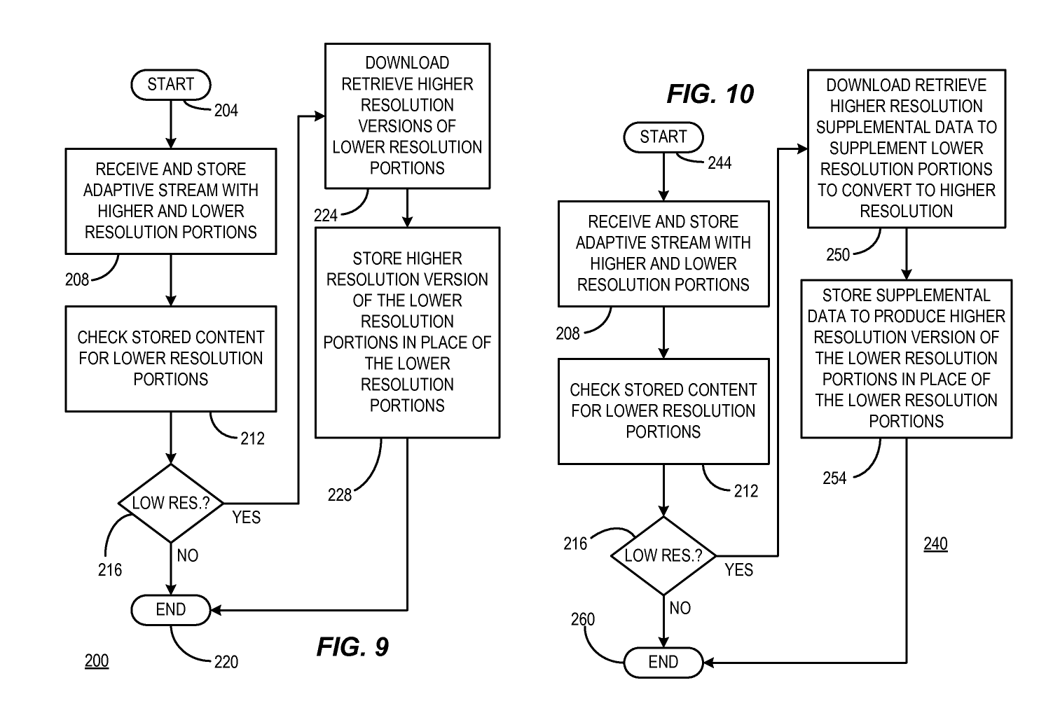

FIG. 9 is a more detailed example flow chart 200 depicting an implementation of an overall process consistent with certain embodiments of the present invention starting at 204. At 208, the adaptively streamed content is received and stored with both higher and lower resolution portions. The content is then checked, either in a routine forming part of module 70 or as a result of a user action or other mechanism, to see if the content contains lower resolution portions at 212. If not, the process ends at 220. But, if lower resolution portions are detected at 216, the process takes action to download higher resolution portions from the source 10 at 224. Those higher resolution portions are stored in place of the lower resolution portions at 228 and the process ends at 220. The user can then playback the content at any time in the full higher resolution form from local storage 66.

FIG. 10 is a more detailed example flow chart 240 depicting another implementation of an overall process consistent with certain embodiments of the present invention starting at 244. At 208, the adaptively streamed content is received and stored with both higher and lower resolution portions. The content is then checked, either in a routine forming part of module 70 or as a result of a user action or other mechanism, to see if the content contains lower resolution portions at 212. If not, the process ends at 260. But, if lower resolution portions are detected at 216, the process takes action to download supplemental data at 250 that can be utilized to convert the lower resolution portions to higher resolution portions from the source 10 at 250. Those higher resolution portions or the supplemental data are stored in place of or in addition to respectively the lower resolution portions at 254 and the process ends at 260. The user can then playback the content at any time in the full higher resolution form from local storage 66.

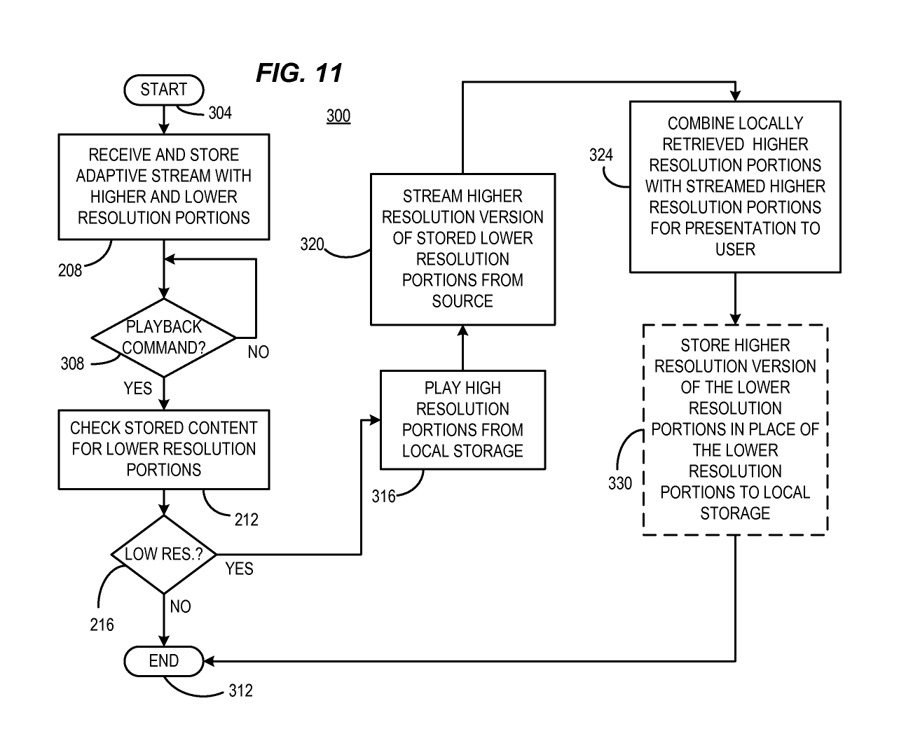

FIG. 11 is a more detailed example flow chart 300 depicting another implementation of an overall process consistent with certain embodiments of the present invention starting at 304. At 208, the adaptively streamed content is received and stored with both higher and lower resolution portions. At 308, the user issues a playback command which initiates a check at 212 to see if the content contains lower resolution portions at 212. If not at 216, the upgrade process ends at 312 and the user proceeds with retrieval and playback of the content from local storage 66. Otherwise, at 216 control passes to 316 where the higher resolution portions are played from local storage and a higher resolution version of the locally stored portions are streamed at 320 from source 10 to supplement the locally stored higher resolution portions. At 324, the locally retrieved higher resolution portions are combined with the streamed higher resolution portions for presentation to the user. Optionally, the higher resolution version of at least the lower resolution portions can be stored locally to replace the lower resolution portions at 330 and the process ends at 312.

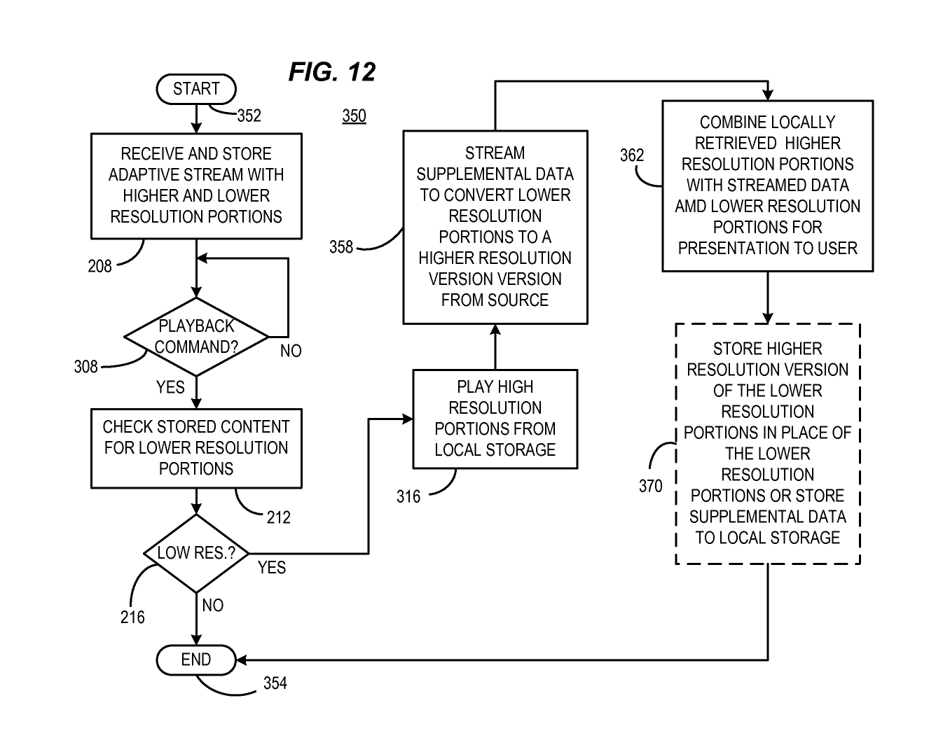

FIG. 12 is a more detailed example flow chart 350 depicting another implementation of an overall process consistent with certain embodiments of the present invention starting at 352. At 208, the adaptively streamed content is received and stored with both higher and lower resolution portions. At 308, the user issues a playback command which initiates a check at 212 to see if the content contains lower resolution portions at 212. If not at 216, the upgrade process ends at 354 and the user proceeds with retrieval and playback of the content from local storage 66. Otherwise, at 216 control passes to 316 where the higher resolution portions are played from local storage and a supplemental data that converts the lower resolution portions to higher resolution versions of the locally stored portions are streamed at 358 from source 10 to supplement the locally stored higher resolution portions. At 362, the locally retrieved higher resolution portions are combined with the higher resolution portions created by the combination of the lower resolution portions stored locally and the streamed data for presentation to the user. Optionally, the higher resolution version of at least the lower resolution portions or the supplemental data can be stored locally to replace or supplement the lower resolution portions at 370 and the process ends at 354.

Thus, a method consistent with certain implementations involves receiving an adaptively streamed stream of data representing the A/V content from a source where the stream contains a high resolution representation of at least a first portion of the content and a lower resolution representation of at least a second portion of the content; storing the stream of data to an electronic storage device; determining that the stored stream of data includes the lower resolution representation of the at least second portion of the content; changing the lower resolution representation of the at least second portion of the content to a high resolution representation of the at least second portion of the content; and producing a high resolution output stream of data representing the A/V content by combining the high resolution representation of the at least first portion of the content from the storage device with the high resolution representation of the at least second portion of the content.

In certain implementations, the low resolution representation of the at least second portion of the content is changed by streaming the high resolution representation of the at least second portion of the content from the source. In certain implementations, the low resolution representation of the at least second portion of the content is changed by streaming supplementary data that supplements the low resolution representation of the at least second portion of the content from the source, where the supplementary data is used to increase the resolution of the at least second portion of the content to the high resolution representation. In certain implementations, the method further involves retrieving from the source a high resolution representation of the at least second portion of the content; and replacing the low resolution representation of the at least second portion of the content with the high resolution representation of the at least second portion of the content stored in the storage device; and where the output stream is produced in full from the electronic storage device. In certain implementations, the method further involves retrieving supplementary data that supplements the low resolution representation of the at least second portion of the content from the source, where the supplementary data is used to increase the resolution of the at least second portion of the content to the high resolution representation; storing the supplementary data to the storage device; and where the output stream is produced in full from the electronic storage device. In certain implementations, the changing is carried out in response to receiving a playback command. In certain implementations, the method further involves storing a high resolution representation of the at least second portion of the content. In certain implementations, the method further involves presenting the high resolution representation of the at least first and at least second portions of the content to a user by display of the content on a display device. In certain implementations, the adaptively streamed content is received as IPTV data over the Internet. In certain implementations, the adaptively streamed content is displayed in real time as it is being received and prior to producing the high resolution output.

Another method consistent with certain embodiments involves receiving and displaying an adaptively streamed stream of IPTV data representing the A/V content over the Internet from a source where the stream contains a high resolution representation of at least a first portion of the content and a lower resolution representation of at least a second portion of the content; storing the stream of data to an electronic storage device. In response to a playback command: the method involves determining that the stored stream of data includes the lower resolution representation of the at least second portion of the content, and producing a high resolution output stream of data representing the A/V content by combining the high resolution representation of the at least first portion of the content from the storage device with a high resolution representation of the at least second portion of the content that is streamed in real time from the source; and presenting the high resolution representation of the at least first and at least second portions of the content to a user by display of the content on a display device.

Any of the above methods can be implemented using a storage medium such as a non-transitory computer readable storage medium storing instructions which, when executed on one or more programmed processors.

An apparatus consistent with certain implementations has an input circuit that receives an adaptively streamed stream of data representing the A/V content, where the stream contains a high resolution representation of at least a first portion of the content and a lower resolution representation of at least a second portion of the content. A programmed processor is provided. An electronic storage device stores the stream of data under control of the processor. The processor is programmed to determine that the stored stream of data includes the lower resolution representation of the at least second portion of the content. The processor is further programmed to change the lower resolution representation of the at least second portion of the content into a high resolution representation of the at least second portion of the content. An output circuit produces a high resolution output stream of data representing the A/V content as a combination of the high resolution representation of the at least first portion of the content from the storage device and the high resolution representation of the at least second portion of the content.

In certain implementations, the low resolution representation of the at least second portion of the content is changed by streaming the high resolution representation of the at least second portion of the content from the source. In certain implementations, the low resolution representation of the at least second portion of the content is changed by streaming supplementary data that supplements the low resolution representation of the at least second portion of the content from the source, where the supplementary data is used to increase the resolution of the at least second portion of the content to the high resolution representation. In certain implementations, the processor is programmed to change the lower resolution representation to a high resolution representation by: retrieving from the source a high resolution representation of the at least second portion of the content; and replacing the low resolution representation of the at least second portion of the content with the high resolution representation of the at least second portion of the content stored in the storage device; and where the output stream is produced in full from the electronic storage device.

In certain implementations, the processor is programmed to change the lower resolution representation to a high resolution representation by: retrieving supplementary data that supplements the low resolution representation of the at least second portion of the content from the source, where the supplementary data is used to increase the resolution of the at least second portion of the content to the high resolution representation; storing the supplementary data to the storage device; and where the output stream is produced in full from the electronic storage device.

In certain implementations, the changing is carried out in response to receiving a playback command. In certain implementations, the high resolution representation of the at least second portion of the content is stored in the storage device. In certain implementations, the high resolution representation of the at least first and at least second portions of the content is presented to a user by display of the content on a display device. In certain implementations, the adaptively streamed content is received as IPTV data over the Internet. In certain implementations, the adaptively streamed content is displayed on a display device in real time as it is being received and prior to producing the high resolution output.

Certain embodiments described herein, are or may be implemented using one or more programmed processors executing programming instructions that are broadly described above in flow chart form that can be stored on any suitable electronic or computer readable storage medium such as a non-transitory storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied or carried out in parallel, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method, comprising:
receiving an adaptively streamed stream of data representing the A/V content from a source where the stream contains a high resolution representation of at least a first portion of the content and a lower resolution representation of at least a second portion of the content;
storing the stream of data to an electronic storage device;
determining that the stored stream of data includes the lower resolution representation of the at least second portion of the content;
changing the lower resolution representation of the at least second portion of the content to a high resolution representation of the at least second portion of the content; and
producing a high resolution output stream of data representing the A/V content by combining the high resolution representation of the at least first portion of the content from the storage device with the high resolution representation of the at least second portion of the content.

2. The method according to claim 1, where the low resolution representation of the at least second portion of the content is changed by streaming the high resolution representation of the at least second portion of the content from the source.

3. The method according to claim 1, where the low resolution representation of the at least second portion of the content is changed by streaming supplementary data that supplements the low resolution representation of the at least second portion of the content from the source, where the supplementary data is used to increase the resolution of the at least second portion of the content to the high resolution representation.

4. The method according to claim 1, further comprising:
retrieving from the source a high resolution representation of the at least second portion of the content; and
replacing the low resolution representation of the at least second portion of the content with the high resolution representation of the at least second portion of the content stored in the storage device; and
where the output stream is produced in full from the electronic storage device.

5. The method according to claim 1, further comprising:
retrieving supplementary data that supplements the low resolution representation of the at least second portion of the content from the source, where the supplementary data is used to increase the resolution of the at least second portion of the content to the high resolution representation;
storing the supplementary data to the storage device; and
where the output stream is produced in full from the electronic storage device.

6. The method according to claim 1, where the changing is carried out in response to receiving a playback command.

7. The method according to claim 1, further comprising storing a high resolution representation of the at least second portion of the content.

8. The method according to claim 1, further comprising presenting the high resolution representation of the at least first and at least second portions of the content to a user by display of the content on a display device.

9. The method according to claim 1, where the adaptively streamed content is received as IPTV data over the Internet.

10. The method according to claim 1, further comprising displaying the adaptively streamed content in real time as it is being received and prior to producing the high resolution output.

11. A non-transitory computer readable storage medium storing instructions which, when executed on one or more programmed processors, carry out a method according to claim 1.

12. A method, comprising:
Receiving and displaying an adaptively streamed stream of IPTV data representing the A/V content over the Internet from a source where the stream contains a high resolution representation of at least a first portion of the content and a lower resolution representation of at least a second portion of the content;
storing the stream of data to an electronic storage device;
in response to a playback command:
determining that the stored stream of data includes the lower resolution representation of the at least second portion of the content, and
producing a high resolution output stream of data representing the A/V content by combining the high resolution representation of the at least first portion of the content from the storage device with a high resolution representation of the at least second portion of the content that is streamed in real time from the source; and
presenting the high resolution representation of the at least first and at least second portions of the content to a user by display of the content on a display device.

13. An apparatus, comprising:
an input circuit that receives an adaptively streamed stream of data representing the A/V content, where the stream contains a high resolution representation of at least a first portion of the content and a lower resolution representation of at least a second portion of the content;
a programmed processor;
an electronic storage device that stores the stream of data under control of the processor;
the processor being programmed to determine that the stored stream of data includes the lower resolution representation of the at least second portion of the content;
the processor being further programmed to change the lower resolution representation of the at least second portion of the content into a high resolution representation of the at least second portion of the content; and
an output circuit that produces a high resolution output stream of data representing the A/V content as a combination of the high resolution representation of the at least first portion of the content from the storage device and the high resolution representation of the at least second portion of the content.

14. The apparatus according to claim 13, where the low resolution representation of the at least second portion of the content is changed by streaming the high resolution representation of the at least second portion of the content from the source.

15. The apparatus according to claim 13, where the low resolution representation of the at least second portion of the content is changed by streaming supplementary data that supplements the low resolution representation of the at least second portion of the content from the source, where the supplementary data is used to increase the resolution of the at least second portion of the content to the high resolution representation.

16. The apparatus according to claim 13, where the processor is programmed to change the lower resolution representation to a high resolution representation by:
retrieving from the source a high resolution representation of the at least second portion of the content; and
replacing the low resolution representation of the at least second portion of the content with the high resolution representation of the at least second portion of the content stored in the storage device; and
where the output stream is produced in full from the electronic storage device.

17. The apparatus according to claim 13, where the processor is programmed to change the lower resolution representation to a high resolution representation by:
retrieving supplementary data that supplements the low resolution representation of the at least second portion of the content from the source, where the supplementary data is used to increase the resolution of the at least second portion of the content to the high resolution representation;
storing the supplementary data to the storage device; and
where the output stream is produced in full from the electronic storage device.

18. The apparatus according to claim 13, where the changing is carried out in response to receiving a playback command.

19. The apparatus according to claim 13, further comprising storing the high resolution representation of the at least second portion of the content.

20. The apparatus according to claim 13, further comprising presenting the high resolution representation of the at least first and at least second portions of the content to a user by display of the content on a display device.

21. The apparatus according to claim 13, where the adaptively streamed content is received as IPTV data over the Internet.

22. The apparatus according to claim 13, where the adaptively streamed content is displayed on a display device in real time as it is being received and prior to producing the high resolution output.
